(19) United States
(12) Patent Application Publication
(10) Pub. No.: US 2025/0304794 A1
(43) Pub. Date: Oct. 2, 2025

(54) SCRUB SEALER COMPOSITION, METHOD, AND APPLICATION BOX

(71) Applicant: Idaho Asphalt Supply, Inc., Idaho Falls, ID (US)

(72) Inventors: Douglas Ray OLSEN, Reno, NV (US); Huachun ZHAI, Boise, ID (US)

(73) Assignee: Idaho Asphalt Supply, Inc., Idaho Falls, ID (US)

(21) Appl. No.: 19/087,509

(22) Filed: Mar. 22, 2025

Related U.S. Application Data
(60) Provisional application No. 63/572,764, filed on Apr. 1, 2024.

(51) Int. Cl. C08L 95/00; C08J 3/03; C08J 3/21; E01C 7/18

(52) U.S. Cl. CPC C08L 95/005; C08J 3/03; C08J 3/212; E01C 7/187; C08L 2207/24; C08L 2555/22; C08L 2555/64

(57) ABSTRACT

This disclosure relates to a method of preparing a scrub sealer. The method includes preparing an asphalt emulsion, and preparing a premixture of at least two different types of aggregate. The method also includes passing the asphalt emulsion and the premixture through a mixer to form the scrub sealer.

### RELATED APPLICATIONS

This application is based on and claims the benefit of priority from U.S. Provisional Application No. 63/572,764 that was filed on Apr. 1, 2024, the contents of which are expressly incorporated herein by reference.

### TECHNICAL FIELD

The present disclosure relates generally to a scrub sealer composition and, more particularly, to the composition, to a method of preparing the composition, and to a scrub box advantageously used to apply the composition.

### BACKGROUND

For the purposes of this disclosure, a road can be considered a durable surface (e.g., a route, way, path, drive, street, lane, lot, or similar thoroughfare or park) that has been prepared on land or over water to support any one or more of various types of traffic (e.g., vehicular traffic, pedestrian traffic, railway traffic, aircraft ground traffic, bicycle traffic, etc.). While roads can be constructed in a variety of different ways, most of these ways involve the application of a specialized material to an existing or newly prepared surface.

Asphalt is one example of a material specially prepared for use in building roads. Asphalt, also known as bitumen, is a binder used to adhere filler or reinforcement (e.g., sand, aggregate, etc.) together and to the underlying surface. An asphalt road is durable and flexible, allowing expansion and contraction without damage. The asphalt can be asphalt cement (AC), polymer modified asphalt (PMA), cutback, and emulsions. Other materials (e.g., primers, hardeners, additives, etc.) may be used together with asphalt when building roads.

Over time, an asphalt road can deteriorate and should be maintained to extend its useful life. For example, cracks can form within the road surface. If not otherwise accounted for, these cracks can fill with water that freezes and expands during the winter. The expansion causes the cracks to propagate until they penetrate through a depth of the road and the road breaks apart. However, if the surface cracks can be treated before they propagate through the depth of the road, the road may continue to be used for an extended period of time. One way to treat road deterioration is to apply a seal made from an asphalt slurry (a.k.a., a slurry seal) onto the surface of the road.

A conventional slurry seal is a mixture of asphalt emulsion, graded aggregates, mineral filler, water, and other additives. The constituents of the mixture are maintained separately onboard a Slurry Surfacing Machine (“SSM”), and selectively metered into a pugmill mounted at the trailing end of the SSM during sealing of the road. The mixture is free-flowing and sent from the pugmill into a spreader box that is towed behind the SSM. The spreader box spreads the mixture in an even manner across the width of the road as the SSM travels down a length of the road.

Conventional slurry seals, while adequate for treatment of some road deterioration, may be inappropriate for treating cracks. For example, conventional slurry seals may oxidize and become inelastic. When a road is exposed to varying temperatures, it will naturally expand and contract. Because the traditional slurry seals can become inelastic, they will crack, unravel, or otherwise fail.

An improved slurry seal used to fill cracks is disclosed in U.S. Pat. No. 8,808,445 that issued to Coe on Aug. 19, 2014 (the '445 patent). The slurry seal of the '445 patent is known as an asphalt-rubber binder (ARB) and includes crumb rubber added to an asphalt binder. The '445 patent discloses immersing finely ground (80-140 mesh) tire rubber into a waterless polymer-modified asphalt (e.g., asphalt, an anhydrous surfactant, and fatty acids, rosins, or solvents) under steady stirring at 300-350° F. to form a rubber adhesive. The rubber adhesive is then compounded under high shear with an asphalt emulsion (e.g., an emulsion made from 50-70% asphalt, 30-40% water, and 0.5-4% surfactant) and formulated as a seal that can be spread or sprayed onto the road surface. The addition of the crumb rubber reduces oxidative hardening that leads to cracking of the road.

While the slurry seal of the '445 patent may improve resistance to cracking, it is less than optimal. For example, the multi-stage process disclosed for mixing the slurry seal is complex, time consuming, expensive, and difficult to do on site. That is, the number of mixing steps and high temperatures create extreme requirements that are not easily achievable away from a plant environment. Because the slurry seal of the '445 patent cannot be done on site, a delayed time between mixing and application results in settling of solids out of the emulsion. This settling requires expensive and time-consuming cleanup of associated storage tanks, and results in non-repeatable applications and/or poor seal performance.

The disclosed scrub sealer composition, method and application box are directed at addressing these issues and/or other issues of the prior art.

### SUMMARY

In a first aspect, the present disclosure is directed to a method of preparing a scrub sealer. The method includes preparing an asphalt emulsion, and preparing a premixture of at least two different types of aggregate. The method also includes passing the asphalt emulsion and the premixture through a mixer to form the scrub sealer.

In another aspect, the present disclosure is directed to a scrub sealer for use in filling cracks in a road. The scrub sealer may include an asphalt emulsion and an aggregate premixture. The asphalt emulsion may include water, asphalt, and polymer. The aggregate premixture may include a first type of aggregate, and a crumb rubber.

### BRIEF DESCRIPTION OF THE DRAWINGS

FIG. 1 is a diagrammatic illustration of an example system that may be used to build and/or maintain at least a portion of a road;

FIG. 2 is a diagrammatic illustration of an example scrub box that makes up a portion of the system of FIG. 1; and

FIGS. 3 and 4 are diagrammatic illustrations of example portions of the scrub box of FIG. 2.

### DETAILED DESCRIPTION

The terms “about” and/or “generally” as used herein serve to reasonably encompass or describe minor variations in numerical values measured by instrumental analysis or as a result of sample handling. Such minor variations may be considered to be “within engineering tolerances” and in the order of plus or minus 0% to 10%, plus or minus 0% to 5%, or plus or minus 0% to 1%, of the numerical values.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

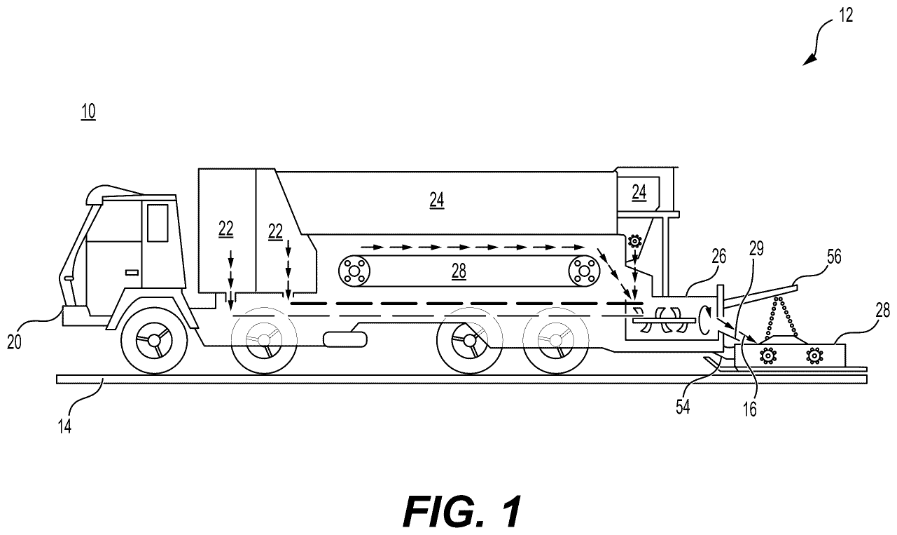

FIG. 1 illustrates a work environment 10, in which one or more machines 12 are performing a road-maintaining operation. It should be noted that, while maintenance of an existing road 14 will be discussed in detail below, the concepts disclosed in this specification may be equally applicable to new road building, rehabilitation and/or preservation of an existing road 14.

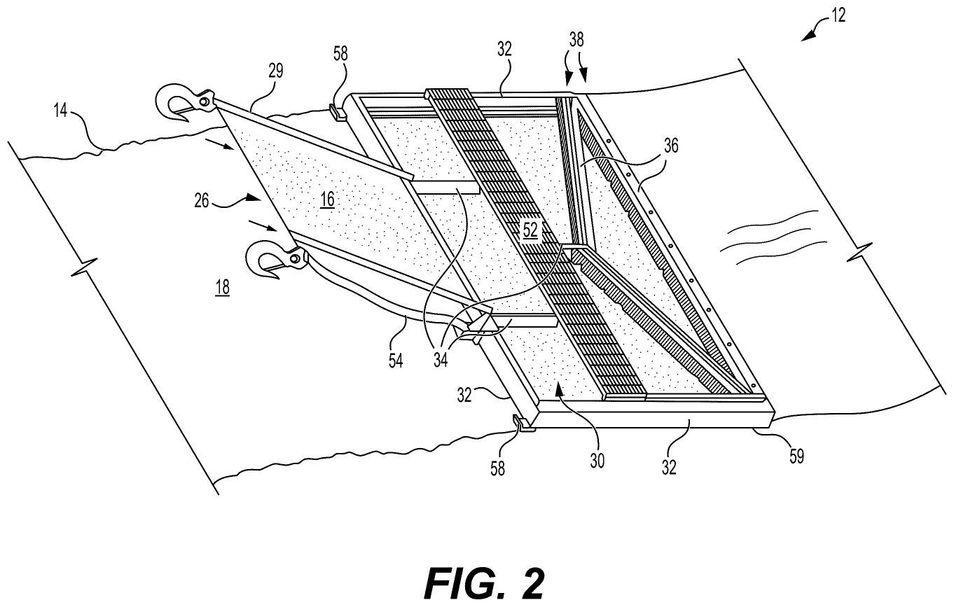

As shown in FIGS. 1 and 2, machine(s) 12 may be configured to apply one or more materials 16 to an existing or newly prepared surface 18 to form, build up, treat and/or repair at least a portion of road 14. As will be explained in more detail below, the material may be known as a scrub sealer. It should be noted that, while machine(s) 12 will be described in detail as land-based machines, any one or more of the disclosed machine(s) 12 could embody a non-land based machine (e.g., an aerial drone) configured to perform the same or similar operations, if desired. It is also contemplated that the configurations of and/or operations disclosed as being performed by a single machine 12 could alternatively be distributed among multiple different machines 12. Likewise, it is contemplated that the configurations of and/or operations disclosed as being performed by multiple different machines 12 could alternatively be integrated into a lesser number of (e.g., one) machines 12.

In the example of FIG. 1, a first machine (e.g., the left-most machine shown as a slurry seal machine—“SSM”) 12 is connected to tow a second machine (e.g., the right-most machine shown as a scrub box—“scrub box”) 12. SSM 12 may include components that cooperate to contain, transport, mix, and pour materials 16 into scrub box 12. Scrub box 12 may include components that receive the materials and apply the materials to road 14 in an equally distributed manner. In another embodiment (not shown), first machine 12 may be nothing more than a tractor configured to tow another machine. In this other embodiment, second machine 12 may be an SSM having an integral or tow-behind scrub box. Other configurations may also be possible.

The components of SSM 12 may include, among other things, a vehicle 20, one or more vessels 22, one or more hoppers 24, one or more mixers 26, and one or more conveyors 28 that convey the constituents of materials 16 from vessel(s) and/or hopper(s) 24 into mixer(s) 26. In the specific embodiment shown in FIG. 1, SSM 12 includes two separate vessels (e.g., an emulsion vessel and an additive vessel) 22, a single hopper (e.g., an aggregate hopper) 24, a single mixer (e.g., a pugmill) 26, and a single conveyor 28. Other configurations, however, are considered.

Vehicle 20 may, itself, be an assembly of components that supports and/or powers the other components of machine 12. In the disclosed embodiment, these components may include a chassis, a power source mounted to the chassis, a drivetrain that is operatively connected to and driven by the power source, and one or more propulsion devices powered by the drivetrain. The power source may include any source known in the art for powering a vehicle. Example sources include an engine (e.g., a gasoline engine, a diesel engine, a gaseous fuel-powered engine, etc.), a battery, or a hybrid engine/battery configuration. Example drivetrains include a transmission, a driveline, a final drive, one or more electric motors, and/or a hybrid transmission/final drive or electric motor configuration. Example propulsion devices include wheels, tracks, feet, fans, jets, blades, and/or propellers.

Each vessel 22 may be equipped to receive, hold, condition, and/or discharge a flowable material (e.g., a liquid). For example, each vessel 22 may include an inlet to receive the liquid, an outlet to discharge the liquid, and any number of conditioning devices (e.g., mixers, agitators, heaters, coolers, recirculation circuits, sensors, valves, conduits, additive injectors, etc.) located between the inlet and outlet that serve to condition the liquid inside vessel 22. In some applications, a valve or other metering device (not shown) may be associated with the outlet of vessel 22 to regulate the flowrate of liquid leaving vessel 22. In the disclosed embodiment, a liquid-type of conveyor 28 (e.g., a conduit with or without a conveying mechanism, such as a pump or auger) may extend between the outlet of vessel 22 and an inlet of mixer 26.

Each hopper 24 may be equipped to receive, hold, condition, and/or discharge a non-flowable (e.g., solid) material. For example, each hopper 24 may include an opening to receive the solid and an outlet to discharge the solid. Because the solid material may not readily flow, the outlet of hopper 24 may be located at a gravitationally lowest position of hopper 24. For example, the outlet may be within a floor of hopper 24. It is contemplated that each hopper 24 could further include a conditioning device, if desired. In some applications, a gate or other metering device (not shown) may be associated with the outlet of hopper 24 to regulate a rate of solid material leaving vessel 22. In the disclosed embodiment, a solid-type of conveyor 28 (e.g., a conveyor belt, conduit with internal auger, etc.) may extend between the outlet of hopper 24 and the inlet of mixer 26.

Mixer 26, as a pugmill, may continuously receive the liquids and solids from vessel(s) 22 and hopper(s) 24, continuously mix the materials 16 together, and continuous discharge the mixture into scrub box 12. Mixer 26 may include, among other things, a mixing chamber having an inlet (e.g., an open top) and an outlet, and one or more (e.g., two) shafts disposed in the chamber between the inlet and outlet. The shafts may be oriented axially in alignment with a travel direction of SSM 12 and driven (e.g., by the power source of the SSM 12) to rotate in opposition to each other. The shafts may be outfitted with interleaving/overlapping paddles that are angled to both mix the materials together and to push the resulting scrub seal out of the mixing chamber. A chute 29 or other type of conveying device may be located between mixer 26 and scrub box 12 to convey the scrub sealer from the outlet of mixer 26 into a leading end of scrub box 12. Chute 29 may be a standalone component or form a portion of either mixer 26 or scrub box 12. It is contemplated that other types of mixers having a different configuration may be utilized to mix a scrub sealer from liquid and solid materials stored on SSM 12, if desired.

Scrub box 12 may be towed behind SSM 12 and located to receive the scrub sealer discharging from mixer 26. Scrub box 12 may include a generally box-like (e.g., square or rectangular) containment basin 30 having a plurality of (e.g., at least three) side walls 32 that corral the received scrub sealer, and any number of interior frame portions 34. Containment basin 30 may be open at a bottom side (e.g., a side adjacent surface 18 of road 14) and at an opposing top side. One or more spreading elements 36 may be disposed at least partially inside of a containment basin 30. An example of such an application box is disclosed in U.S. Pat. No. 11,753,778 that issued on Sep. 12, 2023 (the '778 patent) and is assigned to the same Assignee as this Application. The '778 patent is incorporated herein by reference.

Side walls 32 and interior frame portions 34 may provide strength and structural rigidity to scrub box 12, such as to withstand the rigors of the paving environment including uneven surfaces, the weight of people or machine being placed atop scrub box 12, impacts with objects, transport to and from a paving site, and the like. Side walls 32 and interior frame portions 34 may be constructed of any suitably strong material, for example metals, plastics, and/or composites (e.g., glass, carbon, or aramid fiber-reinforced polymers). A leading side wall 32 of containment basin 30 may have a fixed or variable width of about 8-14 feet, while left- and right-side walls 32 may have a fixed or variable depth of about 2-8 feet. Containment basin 30 may or may not have a trailing side wall 32.

Spreading element 36 may be any device or structure adapted to disperse or spread the scrub sealer received from mixer 28 onto surface 18 of road 14, while also scrubbing the scrub sealer into surface 18 (e.g., into the cracks in surface 18). In the disclosed embodiment, spreading element 36 includes one or more brushes (a.k.a., brooms) that are arranged in one or more (e.g., two, three, or four) successive rows 38. Multiple rows 38 of brushes 36 may help distribute the scrub sealer evenly over and into surface 18. However, an excessive number of rows 38 may not significantly improve the distribution, but instead only increase a cost of scrub box 12.

A leading row 38 of brushes 36 in scrub box 12 may be angled (e.g., in one or more directions) relative to a travel direction of SSM 12 and scrub box 12. This angling may facilitate spreading of the scrub sealer from a point of deposition (e.g., from a general midline location within a leading end of scrub box 12) transversely outward to the left- and/or right-side walls 32 of scrub box 12. As shown in FIG. 2, the leading row 38 of brushes 36 is angled in two opposing directions (e.g., mirrored about the midline of scrub box 12), such that the leading row 38 forms a chevron shape having a center or vertex located closer towards SSM 12 than trailing ends.

At least one row 38 of brushes 36 may trail the leading row 38. In some applications, this trailing row 38 may form an end wall of containment basin 30. In other embodiments, a dedicated end wall (not shown) may trail behind the trailing row 38. In the disclosed application, the trailing row 38 is generally straight and perpendicular to the travel direction of SSM 12 and scrub box 12. This straight and perpendicularly oriented row 38 may facilitate formation of a smooth and even contour within surface 18. It should be noted, however, that other configurations of the trailing end row 38 are considered.

In some applications, scrub box 12 may include a deck 52. Deck 52 may be any suitable structure or material (e.g., steel, aluminum, plastic, composite, etc.) configured to support the weight of one or more users. For example, deck 52 may be formed of a grate, plate, or similar structure that extends between the left- and right-side walls 32 of containment basin 30. Deck 52 may be removably attached to scrub box 12, if desired.

Scrub box 12 may be towed behind SSM 12 (referring to FIG. 1) via at least one traction element 54. In the example shown, scrub box 12 includes two (e.g., left- and right-located) traction elements 54. Each traction element 54 may embody a chain, strap, bar, tongue, hitch, or the like. A control element (e.g., a shaft, a bar, a post, etc.—not shown) may be provided to help control a lateral position of scrub box 12 relative to SSM 12.

In some implementations, a lift mechanism may be provided to raise or lower scrub box 12 relative to surface 18. For example, as shown in FIG. 1, SSM 12 and/or scrub box 12 is outfitted with a mechanism (e.g., an arm, lever, pulley, traction element, motor, cylinder, actuator, etc.) 56 that is operative to raise and lower scrub box 12. Mechanism 56 may be operated manually or automatically, as desired. It may be advantageous to raise or lower scrub box 12 based on the scrub seal being applied, the condition of surface 18, a speed at which SSM 12 moves along road 14, a desired thickness of road 14, and/or other factors.

One or more shoes 58 may be provided at a lower portion of scrub box 12. Each shoe 58 may be any device or structure that aids in moving scrub box 12 over surface 18, such as by reducing a coefficient of friction (either static or dynamic) between scrub box 12 and surface 18. That is, shoes 58 may help scrub box 12 to slide along surface 18 more easily than in the absence of shoes 58. In the disclosed embodiment, each shoe 58 embodies a ski having a raised forward portion and a horizontally disposed body portion. Shoes 58 may be provided on any portion of scrub box 12, such as side walls 32. In some implementations, each ski-like shoe 58 could be replaced with a different friction reducing device (e.g., a dolly, wheel, caster, roller, slider, drum, disk, skid, etc.), if desired.

Scrub box 12 may include one or more sealing elements 59 suitable to seal a gap formed by shoes 58 (e.g., between side walls 32 and surface 18). Sealing elements 59 may be made of a pliant material such as an elastomer (e.g., natural or synthetic rubber) that can flex with variations in surface 18 and/or height changes created by lifting/lowering scrub box 12. Sealing elements 59, by flexing to fill the above-described gap, may help corral the scrub sealer inside of containment basin 30.

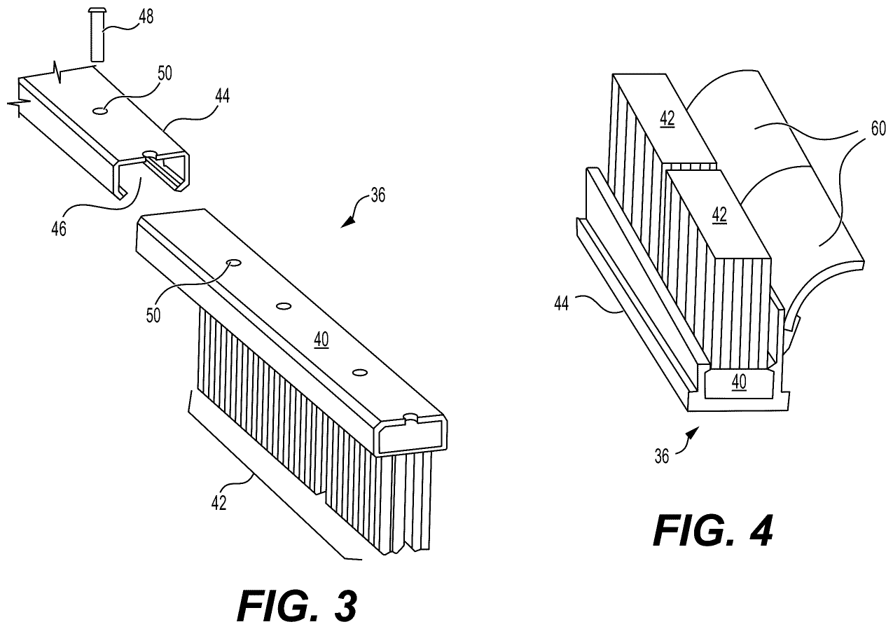

As shown in FIGS. 3 and 4, brush 36 may include a body 40 and a plurality of spreading protrusions (e.g., bristles, fingers, etc.) 42 received within or attached to body 40. In this configuration, body 40 may support and retain spreading protrusions 42. Spreading protrusions 42 may be individually distributed along an underside (i.e., a side facing surface 18) of body 40 or arranged in groups. Spreading protrusions 42 may have any suitable stiffness or flexibility.

In one specific embodiment intended specifically for use with the disclosed scrub sealer, brush 36 may include an HDPE black plastic body 40 that is about 2.5″ wide, 12″ long, and 1″ thick. One or more through-holes may be formed in a lengthwise and widthwise center of body 40 for connection to the rest of containment basin 30. Two rows of polypropylene bristles 42 may be attached to body 40 and extend in the lengthwise direction, each row having a trim length of about 6″. Bristles 42 may be arranged into distinct groupings known as tufts, with a different number of tufts in each of the rows such that the tufts are staggered between the rows. The tufts of each row may be arranged into two separate segments located at opposing sides of the center hole. In this disclosed embodiment, the leading row of bristles 42 includes eighteen tufts, while the trailing row of bristles 42 includes twenty tufts. Each tuft of bristles 42 may extend generally perpendicular from the lower surface of body 40.

With this design, bristles 42 of the disclosed brushes 36 may be configured to easily flex, while still creating at least some pressure against an adjacent wave of the scrub sealer. The disclosed arrangement, density, and spacing of bristles 42 may be sufficient to inhibit collection of solids within bristles 42 and/or between the tufts, while also allowing for bleed-through of the associated liquids. Cleaning of the disclosed brushes 36 may be simple, because material may not stick to bristles 36 and easily fall out from between bristles 36 and the associated tufts at conclusion of a paving operation.

In some applications, the particular brushes 36 used within the leading row 38 and the trailing row 38 may be different. For example, the brushes 36 used in the leading row 38 may have stiffer spreading protrusions 42 and/or a greater density of spreading protrusions 42 to facilitate greater movement of the scrub sealer. The brushes 36 in the trailing row 38 may have more flexible spreading protrusions 42 and/or a lower density of spreading protrusions 42 to facilitate a finer or smoother finish to surface 18.

As shown in FIGS. 2 and 3, any number of brushes 36 may be removably arranged into a single row 38. For example, one or more rails 44 (e.g., one rail for straight rows and two rails for a chevron row) may be connected between side walls 32 and/or interior frame portions 34. Each rail 44 may be formed to include an internal channel 46 that can receive bodies 40 in only an axial direction. Once the body 40 of a brush 36 slides axially into the channel 46 of a corresponding rail 44, the brush 36 may be inhibited from exiting channel 46 in a transverse direction. One or more pins 48 (or similar retention members) may extend through corresponding bores 50 in rails 44 and bodies 40 to axially position brushes 36 within a given row 38. This configuration of brushes 36 and rails 44 may provide certain advantages, such as enabling fast and easy replacement and/or cleaning of worn, clogged, or dirty spreading protrusions 42.

One or more finishing elements 60 may be associated with one or more brushes 36 and/or one or more rows 38. For example, one or more separate finishing elements 60 may be associated with each individual brush 36 (see FIG. 4) of the trailing row 38, or a single elongated finishing element 60 may be associated with the entire trailing row 38 (not shown). Each finishing element 60 may be any suitable element that applies a final texture and/or appearance to the scrub sealer as the finishing element 60 passes over the scrub sealer.

Finishing element 60 may be fabricated from a flexible material to take the form of a smooth sheet, strip, fabric, or screen. The flexible material may be, for example, an elastomer (e.g., natural or synthetic rubber; a fiber such as cotton, wool, jute, hemp, or synthetic fibers; a metal such as steel, aluminum, etc.; or combinations of these materials (e.g., fiber-reinforced rubber).

In some applications, finishing element 60 may be integral to brush 36. For example, finishing element 60 may be bonded to body 40 (e.g., similar to spreading protrusions 42). In these applications, finishing element 60 may be located to lead spreading protrusions 42 or trail spreading protrusions 42. In other applications, finishing element 60 may be located partway within spreading protrusions 42, such that some spreading protrusions 42 lead finishing element 60 and some other protrusions 42 trail finishing element 60. It is also contemplated that multiple finishing elements 60 could be associated with the same brush 36 (e.g., at leading, trailing, and/or mid locations), if desired.

### INDUSTRIAL APPLICATION

The disclosed machines 12 (i.e., SSM 12 and scrub box 12) may be particularly useful in applying a scrub sealer uniquely formulated and prepared to treat cracks within surface 18 of road 14 and to seal surface 18. Formulation of the scrub sealer, as well as methods of preparation and application will now be disclosed in detail with respect to FIGS. 1-4.

The scrub sealer may be formed onboard SSM 12 from a preformulated asphalt emulsion and a premixed combination of at least two different aggregates. The emulsion may be held within vessel 22 onboard SSM 12, while the premixture may be held within hopper 24. In one embodiment, the emulsion and the premixture are prepared prior to loading into machine 12, for example at a road-material plant.

The emulsion may be prepared by firstly heating a first amount of water (up to 85-160° F. (30-70° C.) together with a surfactant (e.g., a cationic or anionic surfactant) to make a solution. Acid or base may be selective added to the solution to adjust a pH, according to the category of the surfactant used. Secondly, a second amount of hot asphalt may be mixed with the solution and be sheared through a colloid mill rotating at high speed. In some embodiments, the asphalt emulsion is made from a minimum of 65% asphalt (e.g., a minimum of at least 70% asphalt). The asphalt may be heated to about 275-325° F. (135-165° C.). The asphalt may be straight asphalt or a polymer-modified asphalt (i.e., straight asphalt that has been previously mixed together with a polymer). If straight asphalt is used, a polymer may be separately added to the emulsion mixing in the colloid mill. Other ingredients, such as rejuvenators may be added during or after the emulsion production. After loading the emulsion into vessel 22, the emulsion is allowed to cool to environmental temperatures—although cooling is not required prior to application.

In the disclosed embodiment, the polymer may include styrene-butadiene-rubber (SBR), neoprene, oxidized polyethylene wax (OPE), acrylic, styrene-butadiene-styrene (SBS), urethane, ethylene-vinal-acetate (EVA), natural rubber, and/or styrene-isoprene-styrene (SIS). All of these polymers can be added into the solution as a solid or a latex before the colloid mill, or be preblended into the straight asphalt before the colloid mill. They can also be added into the emulsion as a solid or a latex after the colloid mill. The amount of the selected polymer in the emulsion may be 5-10% of the residue resulting from the emulsion after application (i.e., after any water in the emulsion has separated from the other components of the emulsion and/or evaporated). In the disclosed embodiment, the residue may be at least 65% (w/w) of the emulsion directed from vessel 22 into mixer 26.

In the disclosed embodiment, the rejuvenator may be synthetic (e.g., petroleum), natural (e.g., plant-based, such as vegetable biomass and/or oil-tomato, olive, beet, etc.), and/or recycled (e.g., cooking oil). The amount of the selected rejuvenator in the emulsion may be 2-10% of the total emulsion.

The premixture may be prepared by mixing a first amount of a first type of aggregate with at least a second amount of a second type of aggregate. The first type of aggregate may include, for example, crushed stone, recycled asphalt pavement (RAP), carbon black, clay, recycled plastic, or slag. In the disclosed embodiment, the first type of aggregate may have a diameter of about ⅜″ or smaller (e.g., 100% of the first type of aggregate may pass through a screen having apertures of ⅜″). The second type of aggregate may include recycled rubber (a.k.a., crumb rubber) having a standard mesh size of 4-40 (0.187-0.0165″). The second type of aggregate may add up to about 5-20% (e.g., about 10-15%) of the weight of the first type of aggregate, regardless of what other premixture materials are included. For example, for every 100 kg of the first type of aggregate, the premixture may include about 5-20 kg of recycled rubber. It should be noted that the size of the first type of aggregate should generally always be larger than the size of the second type of aggregate. After mixing of the different aggregates together, the premixture is loaded into hopper 24.

It should be noted that, in one specific example, the scrub sealer formulation may be considered a triple-recycled mixture. That is, the rejuvenator selected for the scrub sealer may include a recycled material (e.g., cooking oil); the first type of aggregate selected for the premixture may be RAP; and the use of crumb rubber may be counted as the third recycled material. Accordingly, the disclosed scrub sealer may be very environmentally friendly.

In some applications, additional materials may be loaded onto SSM 12. These materials may include, among other things, a chemical additive (e.g., a breaking agent or catalyst) poured into an additional vessel 22, a fiber (e.g., a synthetic fiber like polyester, or a natural fiber) premixed with the first and second types of aggregate, and/or a mineral filler deposited into an additional hopper 24 known as a “fines feeder.”

Once all constituents of the scrub sealer have been loaded into vessels 22 and hoppers 24, SSM 12 may be connected to tow scrub box 12 (e.g., via traction element(s) 54). Various control mechanisms (e.g., valves, conveyor belts, gates, etc.) may be set to desired levels, opening amounts, speeds, etc. to regulate relative ratios of the emulsion, premixture, and/or other constituents (e.g., the chemical additive, mineral filler, etc.) of the scrub sealer feeding into pugmill 28. Pugmill 28 and conveyors 28 may then be activated to begin mixing the constituents and pouring the resulting scrub sealer into scrub box 12.

As scrub box 12 is towed over surface 18 of road 14, the deposited scrub sealer is distributed from a generally left-right center of containment basin 30 transversely outward toward the left- and right-side walls 32. For example, as scrub box 12 passes over the deposited scrub sealer, the angled leading row 38 of brushes 36 (see FIG. 2) functions as a diverter to generate a wave of the material and to impart lateral force to the wave.

Containment basin 30 may help confine the scrub sealer to an area that should be paved. For example, the leading and left/right side walls 32 (together with sealing elements 59—see FIG. 2) may confine the paving material laterally and/or longitudinally. Such containment may provide for more accurate placement of the scrub sealer on surface 18. For example, lateral containment may provide for consistent lane edges or edges of road 14.

As brushes 36 of each row 38 pass over the scrub sealer, brushes 36 may perform at least two different functions. First, brushes 36 may function as screeds to strike away excess scrub sealer and leave behind a layer having a desired thickness. Second, the individual spreading protrusions (e.g., the bristles) 42 of each brush 36 may function to scrub the scrub sealer down into any cracks that may exist within surface 18.

It should be noted that the disclosed scrub sealer may be applied as the sole layer of material onto an existing roadway surface, as one of multiple layers of scrub sealer applied over the top of each other, and/or as an intermediate layer, as desired. For example, in some applications, the disclosed scrub sealer may be applied to fill cracks and porosity between the aggregate of an existing roadway surface as a semi-permeable membrane in preparation for the application of a different resurfacing system (e.g., a slurry seal, a chip seal, a paving mat, etc.).

The disclosed scrub sealer and method of application provide a simple robust solution to sealing surface-level cracks in a road. For example, because the scrub sealer can be mixed on-site (e.g., on machine 12) at a point-of-use, settling of solids from the scrub sealer may be rare or non-existent. In addition, because the process has few steps and little preparation required, the method may take little time or resources. And the disclosed formulation has been shown to have an extended useful life. It should be noted that the disclosed scrub seal could also or alternatively be mixed offsite (e.g., at a factory setting instead of onboard machine 12), if desired.

The disclosed application box, while applicable to any commercially available slurry, may provide particular synergy when used together with the disclosed scrub sealer. For example, the number and shapes of rows 38, combined with the configuration of brushes 36 (e.g., with the configuration of the disclosed bristles 42 and finishing elements 60), may ensure that the disclosed scrub sealer penetrates deeply into the cracks and that surface 18 is smooth, level, and has a required thickness and texture that may not otherwise be possible.

The foregoing description has broad application. The discussion of any embodiment is meant only to be explanatory and is not intended to suggest that the scope of the disclosure, including the claims, is limited to these examples. In other words, while illustrative embodiments of the disclosure have been described in detail herein, the inventive concepts may be otherwise variously embodied and employed, and the appended claims are intended to be construed to include such variations, except as limited by the prior art.

The foregoing discussion has been presented for purposes of illustration and description and is not intended to limit the disclosure to the form or forms disclosed herein. For example, various features of the disclosure are grouped together in one or more aspects, embodiments, or configurations for the purpose of streamlining the disclosure. However, various features of the certain aspects, embodiments, or configurations of the disclosure may be combined in alternate aspects, embodiments, or configurations. Moreover, the following claims are hereby incorporated into this Detailed Description by this reference, with each claim standing on its own as a separate embodiment of the present disclosure.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for illustration purposes to aid the reader's understanding of the present disclosure, and do not create limitations, particularly as to the position, orientation, or use. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other, unless so stated. Identification references (e.g., primary, secondary, first, second, third, fourth, etc.) are not intended to connote importance or priority, but are used to distinguish one feature from another. The drawings are for purposes of illustration only and the dimensions, positions, order and relative sizes reflected in the drawings attached hereto may not be to scale or may vary in other embodiments.

What is claimed is:

1. A method of preparing a scrub sealer, comprising:
preparing an asphalt emulsion;
preparing a premixture of at least two different types of aggregate; and
passing the asphalt emulsion and the premixture through a mixer to form the scrub sealer.

2. The method of claim 1, wherein preparing the asphalt emulsion includes mixing at least water, a surfactant, and asphalt together.

3. The method of claim 2, wherein preparing the asphalt emulsion includes:
heating the water to about 85-160° F.;
mixing the surfactant with the hot water to form a solution;
heating the asphalt to a temperature of about 275-325° F.; and
mixing the hot water together with the solution to form the asphalt emulsion.

4. The method of claim 2, wherein the asphalt is a minimum of 65% of the emulsion.

5. The method of claim 2, further including mixing a polymer together with at least one of the solution, the asphalt, or the premixture.

6. The method of claim 5, wherein the polymer includes a latex.

7. The method of claim 6, wherein the latex includes at least one of SBR, OPE, SBS, natural rubber, or neoprene.

8. The method of claim 5, wherein the polymer is 5-10% of a residue of the emulsion.

9. The method of claim 5, wherein preparing the asphalt emulsion further includes mixing a rejuvenator together with the polymer, the water, the surfactant and the asphalt.

10. The method of claim 9, wherein:
the rejuvenator includes at least one of petroleum, vegetable biomass, vegetable oil, or recycled cooking oil; and
the rejuvenator is 2-10% of the total emulsion.

11. The method of claim 9, wherein:
the asphalt is a minimum of 65% of the emulsion;
the polymer is 5-10% of a residue of the emulsion; and
the rejuvenator is 2-10% of the total emulsion.

12. The method of claim 1, wherein:
preparing the premixture includes mixing the first type of aggregate with crumb rubber; and
the first type of aggregate includes at least one of crushed stone, RAP, carbon black, recycled plastic, clay or slag.

13. The method of claim 12, wherein:
the first type of aggregate has a size of about ⅜″ or less;
the crumb rubber has a standard mesh size of 4-40; and
a weight of the crumb rubber in the premixture is 10-20% of the weight of the first type of aggregate in the premixture.

14. The method of claim 1, further including loading the asphalt emulsion and the premixture onto a mobile machine, before passing the asphalt emulsion and the premixture through the mixer.

15. The method of claim 14, wherein the mixer is located onboard the mobile machine.

16. A method of sealing a road using the scrub sealer from claim 1, the method of sealing comprising:
pouring the scrub sealer from the mixer into a scrub box towed by the mobile machine; and
using rows of brushes in the scrub box to scrub the scrub sealer into cracks in the road.

17. The method of claim 16, further including applying a road paving system different from the scrub sealer over a layer of the scrub sealer.

18. A scrub sealer as prepared via the method of claim 1.

19. A scrub sealer, comprising:
an asphalt emulsion, including:
water;
surfactant;
asphalt; and
polymer; and
an aggregate premixture, including:
a first type of aggregate; and
a crumb rubber.

20. The scrub sealer of claim 19, wherein the polymer includes at least one of SBR, OPE, SBS, neoprene, natural rubber, acrylic, or vinyl.

21. The scrub sealer of claim 19, wherein the polymer is 5-10% of a residue of the emulsion.

22. The scrub sealer of claim 19, wherein:
the asphalt emulsion further includes a rejuvenator; and
the rejuvenator includes at least one of petroleum, vegetable biomass, vegetable oil, or recycled cooking oil.

23. The scrub sealer of claim 22, wherein:
the asphalt is a minimum of 65% of the emulsion;
the polymer is 5-10% of a residue of the emulsion; and
the rejuvenator is 2-10% of the total emulsion.

24. The scrub sealer of claim 23, wherein:
the first type of aggregate includes at least one of crushed stone, RAP, carbon black, recycled plastic, clay or slag;
the crumb rubber has a standard mesh size of 14-40; and
a weight of the crumb rubber in the premixture is 10-20% of the weight of the first type of aggregate in the premixture.

25. The scrub sealer of claim 24, wherein the weight of the crumb rubber in the premixture is 10-15% of the weight of the first type of aggregate in the premixture.
